(19) United States
(12) Patent Application Publication
(10) Pub. No.: US 2017/0158920 A1
(43) Pub. Date: Jun. 8, 2017

(54) THERMOPLASTIC ADHESIVE SHEET

(71) Applicant: NOK Corporation, Tokyo (JP)

(72) Inventors: Katsuyoshi ARAI, Kanagawa (JP); Shinichiro SANO, Kanagawa (JP); Katsumi ABE, Kanagawa (JP)

(73) Assignee: NOK Corporation, Tokyo (JP)

(21) Appl. No.: 15/308,674

(22) PCT Filed: May 14, 2015
(86) PCT No.: PCT/JP2015/063894

§ 371 Date: Nov. 3, 2016

(30) Foreign Application Priority Data
Jun. 25, 2014 (JP) 2014-130516

(51) Int. Cl. C09J 7/02

(52) U.S. Cl. CPC C09J 7/0275; C09J 2203/33; C09J 2205/102

(57) ABSTRACT

It is an object of the present invention to provide a thermoplastic adhesive sheet excellent in initial adhesiveness to an imide group-containing resin compounded with a filler and also excellent in electrolyte-resistance adhesiveness, and the object is achieved by a thermoplastic adhesive sheet that has a functional group introduced into a surface by surface modification and that is bonded to an imide group-containing resin compounded with a filler. The functional group is preferably at least one selected from the group of a hydroxyl group, a carboxyl group, a carbonyl group, a maleic anhydride group, a fumaric anhydride group, a maleimide group, a fluorosulfuryl group, a metallic base of a sulfonate group, and a sulfonate group.

### FIELD OF THE INVENTIONS

The present invention relates to a thermoplastic adhesive sheet and more particularly to a thermoplastic adhesive sheet bonded to an imide group-containing resin compounded with a filler.

### BACKGROUND OF THE INVENTIONS

Although a thermosetting resin or a thermoplastic resin is used for an interlayer adhesive seal material for a lithium ion secondary battery, the thermosetting resin has significant curing shrinkage leading to a problem of wrinkles and the thermoplastic resin is therefore desirably used.

For weight saving and an improvement in safety, consideration is being given to a bipolar lithium ion secondary battery in which an imide group-containing resin compounded with a filler is used for a current collecting foil (Patent Document 1).

On the other hand, Patent Document 2 describes that when a battery component is made up by joining of a polyolefin resin molded body, a joint surface of the molded body is treated with a fluorine gas-containing gas to add a certain functional group before joining using a reactive hot melt adhesive.

### PRIOR ART DOCUMENTS

### Patent Documents

Patent Document 1: JP-A-2013-261192

Patent Document 2: JP-A-10-261387

### SUMMARY

### Problem to be Solved by the Invention

When an imide group-containing resin compounded with a filler as described in Patent Document 1 is used as an adherend, a thermoplastic resin has problems of difficulty in bonding because of low adhesiveness to the adherend and of low electrolyte-resistance adhesiveness if bonded.

Therefore, a method of enhancing the adhesiveness is used by applying a denaturation treatment to the thermoplastic resin to introduce a functional group; however, this method requires an increased denaturation amount of the functional group for the enhancement of the adhesiveness, which causes the thermoplastic resin itself to swell due to an electrolytic solution that is a highly polar solvent, resulting in a problem that degradation in electrolyte-resistance adhesiveness leads to peeling due to long exposure to the electrolytic solution. If the denaturation amount is small, an adhesion force is hardly improved.

On the other hand, if a certain functional group is added to a joint surface of a molded body before joining using a reactive hot melt adhesive as described in Patent Document 2, properties such as conductivity of the surface may change due to the introduction of the functional group when the molded body is, for example, a current collecting foil. For example, it is conceivable that the functional group is selectively introduced only into a part to which the reactive hot melt adhesive is applied; however, this requires steps such as masking for preventing the fluorine gas-containing gas from contacting a portion in which introduction of the functional group is not desired and peeling the mask after the treatment, and the method has room for improvement in terms of simplification of steps. Additionally, Patent Document 2 is directed to the case of the molded body made of a polyolefin resin and does not provide an improvement in adhesion of the imide group-containing resin compounded with a filler described above.

It is therefore a problem of the present invention to provide a thermoplastic adhesive sheet excellent in initial adhesiveness to an imide group-containing resin compounded with a filler and also excellent in electrolyte-resistance adhesiveness.

Other problems of the present invention will become apparent from the following description.

### Means for Solving Problem

The problem is solved by the following aspects of the invention.

1. A thermoplastic adhesive sheet having a functional group introduced into a surface by surface modification, the thermoplastic adhesive sheet being bonded to an imide group-containing resin compounded with a filler.

2. The thermoplastic adhesive sheet according to 1, wherein the functional group is at least one selected from the group of a hydroxyl group, a carboxyl group, a carbonyl group, a maleic anhydride group, a fumaric anhydride group, a maleimide group, a fluorosulfuryl group, a metallic base of a sulfonate group, and a sulfonate group.

3. The thermoplastic adhesive sheet according to 1 or 2, wherein the thermoplastic adhesive sheet is formed by surface modification of a polyolefin resin.

4. The thermoplastic adhesive sheet according to any one of 1 to 3, wherein a proportion of a modification thickness to an entire thickness of the thermoplastic adhesive sheet is within a range of 0.5% to 12%.

5. The thermoplastic adhesive sheet according to any one of 1 to 4, wherein a modification thickness of the surface modification is within a range of 0.5 μm to 12 μm.

### Effect of the Invention

The present invention can provide the thermoplastic adhesive sheet excellent in initial adhesiveness to the imide group-containing resin compounded with a filler and also excellent in electrolyte-resistance adhesiveness.

### BRIEF DESCRIPTION OF THE DRAWINGS

FIG. 1 is a diagram for explaining a test method of initial adhesiveness.

### DETAILED DESCRIPTION OF THE INVENTIONS

A thermoplastic adhesive sheet of the present invention has a functional group introduced into a surface by surface modification and is bonded to an imide group-containing resin compounded with a filler (hereinafter sometimes referred to as a filler-compounded imide group-containing resin).

This thermoplastic adhesive sheet can improve the initial adhesiveness to the filler-compounded imide group-containing resin.

Since the surface modification is used, the functional group can selectively be increased in the surface even if the functional group is increased for ensuring a sufficient adhesion force. Therefore, a modification thickness of the surface modification can be made thinner. As a result, even when being exposed to an electrolytic solution that is a highly polar solvent, the thermoplastic adhesive sheet hardly swells as a whole and the retention of adhesiveness is facilitated. Therefore, an effect is provided that improves a property of facilitating the retention of adhesiveness even after long exposure to the electrolytic solution (this property is sometimes referred to as electrolyte-resistance adhesiveness).

As a result, since a degree of freedom is increased in setting of thickness of the thermoplastic adhesive sheet, a desired thickness is easily applied to ensure a desired interval between members bonded via the thermoplastic adhesive sheet. Therefore, particularly when a plurality of single cell layers including current collecting foils made of the filler-compounded imide group-containing resin is laminated in a lithium ion secondary battery, the sheet can preferably be used for interlayer adhesion. In this case, the thermoplastic adhesive sheet is excellent in initial adhesiveness and electrolyte-resistance adhesiveness to the filler-compounded imide group-containing resin making up the current collecting foils and therefore contributes to the reliability of the battery.

In this description, the “initial adhesiveness” refers to the adhesiveness provided immediately after bonding and may be considered as the adhesiveness before exposure to an electrolytic solution in comparison with the “electrolyte-resistance adhesiveness” described above.

The functional group introduced into the surface of the thermoplastic adhesive sheet by surface modification may preferably be a functional group capable of imparting to the thermoplastic adhesive sheet the adhesiveness to the filler-compounded imide group-containing resin.

Specific examples of such a functional group may preferably include, for example, at least one selected from the group of a hydroxyl group, a carboxyl group, a carbonyl group, maleic anhydride group, a fumaric anhydride group, a maleimide group, a fluorosulfuryl group, a metallic base of a sulfonate group, and a sulfonate group. With these functional groups, the thermoplastic adhesive sheet can produce an effect of further improving the adhesiveness to the filler-compounded imide group-containing resin.

The thermoplastic adhesive sheet is formed by surface modification of a thermoplastic resin and, although the thermoplastic resin used is not particularly limited, a polyolefin resin is particularly preferable.

The polyolefin constituting the polyolefin resin is not particularly limited and may preferably be exemplified by, for example, polyethylene, polypropylene, polybutene, polypentene, polyhexene, polyoctene, polyisobutylene, ethylene-propylene copolymer, and ethylene-butene copolymer, and the like.

For a method of surface modification, a known method may be used without particular limitation as long as the functional group may be introduced into the surface of the thermoplastic resin, and the method may preferably be exemplified by a method using plasma and a method using primer, for example.

If plasma is used, the surface modification may be performed by applying plasma to the surface of the thermoplastic resin that is an object of the surface modification to denature the resin in the surface and generate the functional group.

If primer is used, the surface modification may be performed by, for example, applying primer comprising a resin containing the functional group and a solvent through spraying etc. to the surface of the thermoplastic resin that is an object of the surface modification and by volatilizing the solvent. The resin containing the functional group may preferably be a resin such as polyolefin in which the functional group is introduced by denaturation, for example. The polyolefin may preferably be exemplified by polyethylene, polypropylene, polybutene, polypentene, polyhexene, polyoctene, polyisobutylene, ethylene-propylene copolymer, ethylene-butene copolymer, and the like.

A modification thickness of the surface modification is preferably within a range of 0.5 μm to 12 μm. The modification thickness refers to a thickness of a region in which the functional group is introduced in the surface of the thermoplastic adhesive sheet. For example, if the surface modification is performed by using primer, a thickness of a primer layer after drying (after vaporization of the solvent) corresponds to the modification thickness.

The proportion of the modification thickness to the entire thickness of the thermoplastic adhesive sheet is preferably within a range of 0.5% to 12%. This leads to further improvement in the electrolyte-resistance adhesiveness.

Preferably, the thermoplastic adhesive sheet has the both sides subjected to a surface modification treatment and has the functional group introduced by the surface modification in the both surfaces. As a result, the thermoplastic adhesive sheet may have favorable double-sided adhesive characteristics.

If the thermoplastic adhesive sheet has one surface for an adherend that is the filler-compounded imide group-containing resin and the other surface for an adherend that is other than that (e.g., a resin such as polyolefin), it is also preferable that the functional group be selectively introduced by the surface modification into the one surface for an adherend that is the filler-compounded imide group-containing resin.

The thermoplastic adhesive sheet may be disposed and preferably used between a member made of the filler-compounded imide group-containing resin and another member so as to bond these members. Therefore, in a certain form, the thermoplastic adhesive sheet may be an adhesive sheet bonding a member made of the filler-compounded imide group-containing resin to another member. The other member may be a member made of the filler-compounded imide group-containing resin or others.

When the thermoplastic adhesive sheet of the present invention is used, the filler-compounded imide group-containing resin may preferably be applied as an adherend thereof as described above.

A filler used with the imide group-containing resin is not particularly limited and may preferably be exemplified by, for example, a conductive filler, and specific examples include conductive carbon, tin (Sn), lithium titanate (Li₄Ti₅O₁₂), and the like.

The imide group-containing resin is not particularly limited as long as the resin contains an imide group, and examples thereof may include, for example, polyimide (PI), polyamidimide (PAI), and polyetherimide (PEI), and the like.

At the time of bonding between a modified surface of the thermoplastic adhesive sheet and the filler-compounded imide group-containing resin, the modified surface and the resin are preferably heated and/or pressurized in a laminated state and, specifically, hot-press bonding etc. are preferably used.

### EXAMPLES

Although examples of the present invention will hereinafter be described, the present invention is not limited by the examples.

### Example 1

A thermoplastic adhesive sheet subjected to surface modification was fabricated by spraying and applying onto both surfaces of a polyolefin resin (ethylene-propylene copolymer) sheet an application liquid comprising a solvent and a polyolefin resin (ethylene-propylene copolymer) containing a maleimide group as a functional group followed by drying at 80° C. for 10 minutes to volatilize the solvent to form a primer layer. The thickness of the primer layer (i.e., the modification thickness) was 3 μm. The thickness of the whole thermoplastic adhesive sheet comprising the primer layer was about 100 μm.

<Evaluation Method>

### 1. Initial Adhesiveness

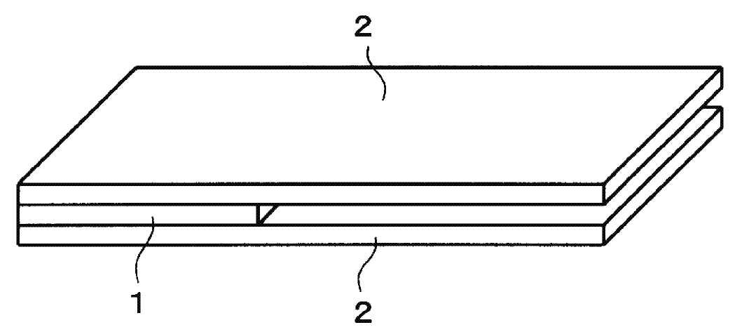

As shown in FIG. 1, two filler-compounded imide group-containing resin sheets 2 were prepared and the sheets 2, 2 were bonded by hot-press bonding via a thermoplastic adhesive sheet 1 fabricated as described above to fabricate a test piece. The filler-compounded imide group-containing resin sheet 2 is made of an imide group-containing resin (polyimide) containing conducting carbon as a filler. The filler-compounded imide group-containing resin sheets 2 have dimensions of 2 cm×5 cm, and the thermoplastic adhesive sheet 1 has dimension of 2 cm×2 cm and thickness of about 100 μm.

For this test piece, a T-peel test was conducted in conformity to JIS K6854-3 (1999) to evaluate the initial adhesiveness based on the measured adhesion strength in accordance with the following evaluation criteria.

(Evaluation Criteria)

A: Adhesion strength is 0.2 N/mm or more.

B: Adhesion strength is 0.1 N/mm to less than 0.2 N/mm.

C: Adhesion strength is less than 0.1 N/mm.

2. Electrolyte-Resistance Adhesiveness

The test piece fabricated in “1. Initial Adhesiveness” was immersed in an electrolytic solution (a mixed solution of equal volumes of propylene carbonate and ethylene carbonate with lithium salt LiPF₆ dissolved at concentration of 1 mol/L) under 45° C. environment and, after the test piece was taken out and washed after 2000 hours, the same T-peel test as “1. initial adhesiveness” was conducted to measure the adhesion strength. Additionally, a state of peeling of the thermoplastic adhesive sheet was visually observed. The results were evaluated in accordance with the following evaluation criteria.

(Evaluation Criteria)

A: Adhesion strength of 0.2 N/mm or more is recognized and no peeling is observed in a periphery.

B: Although adhesion strength of 0.2 N/mm or more is recognized, the peeling is recognized in a periphery.

C: Adhesion strength of 0.2 N/mm or more is not recognized.

### Comparison Example 1

In Example 1, polypropylene without surface modification was used for a thermoplastic adhesive sheet and evaluated by the same evaluation method as Example 1. This thermoplastic adhesive sheet is entirely made of the polypropylene.

### Comparison Example 2

In Example 1, thermoplastic polyester without surface modification was used for a thermoplastic adhesive sheet. Evaluation was made by the same evaluation method as Example 1. This thermoplastic adhesive sheet is entirely made of the thermoplastic polyester.

### Comparison Example 3

In Example 1, reactive polyethylene without surface modification was used for a thermoplastic adhesive sheet and evaluated by the same evaluation method as Example 1. The reactive polyethylene used was polyethylene having a functional group (carboxyl group) introduced therein. This thermoplastic adhesive sheet is entirely made of the reactive polyethylene.

TABLE 1

| | | | electrolyte- |
|---|---|---|---|
| | thermoplastic | initial | resistance |
| | adhesive sheet | adhesiveness | adhesiveness |
| Example 1 | surface-modified | A | A |
| | ethylene-propylene | | |
| | copolymer | | |
| Comparison | polypropylene | C | — |
| Example 1 | | | |
| Comparison | thermoplastic | B | C |
| Example 2 | polyester | | |
| Comparison | reactive | A | C |
| Example 3 | polyethylene | | |

<Evaluation>

Example 1 using the thermoplastic adhesive sheet of the present invention shows that the sheet is excellent in the initial adhesiveness and the electrolyte-resistance adhesiveness to the filler-compounded imide group-containing resin.

On the other hand, Comparison Example 1 using polypropylene without surface modification shows that the initial adhesiveness is low.

Although a certain level of the initial adhesiveness is acquired in Comparison Example 2 using thermoplastic polyester, the sheet is inferior in the electrolyte-resistance adhesiveness. It is presumed that, although a functional group inherently contained in polyester produces a certain level of the initial adhesiveness, the electrolyte-resistance adhesiveness is degraded because of swelling due to the electrolytic solution since the functional group is distributed in the entire adhesive sheet.

Although the initial adhesiveness is not a problem in Comparison Example 3 using the reactive polyethylene subjected to a denaturation treatment for introducing the functional group, the sheet is inferior in the electrolyte-resistance adhesiveness. It is presumed that since the entire adhesive sheet is made of the reactive polyethylene and the functional group is therefore distributed in the entire adhesive sheet, the electrolyte-resistance adhesiveness is degraded because of swelling due to the electrolytic solution.

1. A thermoplastic adhesive sheet having a functional group introduced into a surface by surface modification, the thermoplastic adhesive sheet being bonded to an imide group-containing resin compounded with a filler.

2. The thermoplastic adhesive sheet according to claim 1, wherein the functional group is at least one selected from the group of a hydroxyl group, a carboxyl group, a carbonyl group, a maleic anhydride group, a fumaric anhydride group, a maleimide group, a fluorosulfuryl group, a metallic base of a sulfonate group, and a sulfonate group.

3. The thermoplastic adhesive sheet according to claim 1, wherein the thermoplastic adhesive sheet is formed by surface modification of a polyolefin resin.

4. The thermoplastic adhesive sheet according to claim 1, wherein a proportion of a modification thickness to an entire thickness of the thermoplastic adhesive sheet is within a range of 0.5% to 12%.

5. The thermoplastic adhesive sheet according to claim 1, wherein a modification thickness of the surface modification is within a range of 0.5 μm to 12 μm.

6. The thermoplastic adhesive sheet according to claim 2, wherein the thermoplastic adhesive sheet is formed by surface modification of a polyolefin resin.
